(19) United States
(12) Patent Application Publication
(10) Pub. No.: US 2023/0307791 A1
(43) Pub. Date: Sep. 28, 2023

(54) POWER STORAGE DEVICE

(71) Applicant: KABUSHIKI KAISHA TOYOTA JIDOSHOKKI, Kariya-shi, Aichi (JP)

(72) Inventors: Tatsuya KINUGAWA, Aichi-ken (JP); Takahiro SUGIOKA, Aichi-ken (JP); Yusuke SUGIYAMA, Aichi-ken (JP); Tomoya YAMAJI, Aichi-ken (JP)

(73) Assignee: KABUSHIKI KAISHA TOYOTA JIDOSHOKKI, Kariya-shi, Aichi (JP)

(21) Appl. No.: 18/019,620

(22) PCT Filed: Jul. 26, 2021
(86) PCT No.: PCT/JP2021/027508

§ 371 Date: Feb. 3, 2023

(30) Foreign Application Priority Data
Aug. 7, 2020 (JP) 2020-135307

(51) Int. Cl. H01M 50/46; H01M 10/0585; H01M 4/66; H01M 10/0525

(52) U.S. Cl. CPC H01M 50/461; H01M 10/0585; H01M 4/661; H01M 10/0525

(57) ABSTRACT

A power storage device includes a positive electrode including a positive electrode active material layer formed on a first surface of a positive current collector, a negative electrode including a negative electrode active material layer formed on a first surface of a negative current collector, a separator interposed between the positive electrode active material layer and the negative electrode active material layer, and a sealing portion. One of the positive current collector and the negative current collector is made of aluminum foil having a thickness of 1 to 50 μm. The other is made of aluminum foil having a thickness of 1 to 50 μm, or copper foil having a thickness of 1 to 25 μm. The sealing portion is made of thermoplastic polyolefin-based resin having a peak top temperature of 135° C. or less.

### TECHNICAL FIELD

The present invention relates to a power storage device.

### BACKGROUND ART

Patent Document 1 discloses a flat power storage device formed by stacking a plurality of power storage cells, which is made individually, in series. The above-described power storage cells each include a positive electrode, a negative electrode, and a separator. The positive electrode is formed of a positive current collector made of resin and a positive electrode active material layer formed on a middle portion of one surface of the positive current collector. The negative electrode is formed of a negative current collector made of resin and a negative electrode active material layer formed on a middle portion of one surface of the negative current collector. The negative electrode active material layer is disposed so as to face the positive electrode active material layer. The separator is interposed between the positive electrode and the negative electrode.

In addition, the above-described power storage cells each include a sealing portion made of thermoplastic resin. The sealing portion is disposed on outer peripheries of the positive electrode active material layer and the negative electrode active material layer between the positive electrode and the negative electrode. The sealing portion maintains a distance between the positive current collector and the negative current collector to prevent short circuit between the positive current collector and the negative current collector, and forms a sealed space between the positive current collector and the negative current collector, the sealed space being filled up with a liquid electrolyte.

### CITATION LIST

### Patent Document

Patent Document 1: Japanese Patent Application Publication No. 2017-16825

### SUMMARY OF INVENTION

### Technical Problem

One of methods of increasing energy density of stacked-type power storage cells in which a plurality of positive electrodes and a plurality of negative electrodes are alternately stacked with a separator interposed therebetween is increasing a relative ratio of active material layers in a stacking direction of the power storage cells by using current collectors having a thin foil shape, such as a metal foil. However, when the foil current collectors are applied to the power storage device which is configured as described above, a volume of the sealing portions made of thermoplastic resin changes during heat welding due to a decrease of a proof stress of the current collectors, so that wrinkles are easily formed in the current collectors. The wrinkles of the current collectors cause leakage of the liquid electrolyte due to a lack of sealing in the sealing portions and short circuit between the current collectors.

The present disclosure has been made in view of the above circumstances and is directed to, in a power storage device including current collectors having a foil shape and arranged adjacently in a stacking direction thereof, a sealing portion interposed between any two of the adjacent current collectors, and a sealed space formed of any two of the adjacent current collectors and the sealing portion and accommodating a liquid electrolyte, reducing wrinkles formed in the current collectors.

### Solution to Problem

A power storage device to achieve the above-described purpose includes a positive electrode including a positive electrode active material layer formed on a first surface of a positive current collector, a negative electrode including a negative electrode active material layer formed on a first surface of a negative current collector, the negative electrode active material layer being disposed so as to face the positive electrode active material layer of the positive electrode, a separator interposed between the positive electrode active material layer and the negative electrode active material layer, and a sealing portion disposed between the positive electrode and the negative electrode in such a manner that the sealing portion encloses the positive electrode active material layer and the negative electrode active material layer, the sealing portion adhering to the first surface of the positive current collector and the first surface of the negative current collector to form a sealed space between the positive electrode and the negative electrode, the sealed space accommodating a liquid electrolyte. One of the positive current collector and the negative current collector is made of aluminum foil having a thickness of 1 to 50 μm. The other of the positive current collector and the negative current collector is made of aluminum foil having a thickness of 1 to 50 μm or copper foil having a thickness of 1 to 25 μm. The sealing portion is made of thermoplastic polyolefin-based resin. The thermoplastic polyolefin-based resin has a peak top temperature of 135° C. or less, which corresponds to a welding temperature at which an adhesive strength becomes maximum.

In the above-described power storage device, the other of the positive current collector and the negative current collector is preferably made of copper foil having a thickness of 1 to 25 μm.

In the above-described power storage device, the thermoplastic polyolefin-based resin preferably has a coefficient of linear expansion of 25×10⁻⁵/° C. or less.

In the above-described power storage device, preferably, the power storage device has a structure in which the positive electrode, the negative electrode, and the separator are stacked one another, and a second surface opposite to the first surface in the positive current collector and a second surface opposite to the first surface in the negative current collector are in contact with each other.

A method of manufacturing the power storage device includes: disposing the positive electrode and the negative electrode in such a manner that the positive electrode active material layer and the negative electrode active material layer face each other in a stacking direction with the separator interposed between the positive electrode active material layer and the negative electrode active material layer, and disposing a sealing material on outer peripheries of the positive electrode active material layer and the negative electrode active material layer between the positive electrode and the negative electrode, the sealing material being made of the thermoplastic polyolefin-based resin; and forming the sealing portion by heat welding in which the sealing material is heated at a temperature of 135° C. or less to cause the sealing material to adhere to the positive electrode, the negative electrode, and the separator.

### Advantageous Effect of Invention

According to the present invention, in a power storage device including current collectors having a foil shape and arranged adjacently in a stacking direction thereof, a sealing portion interposed between any two of the adjacent current collectors, and a sealed space formed of any two of the adjacent current collectors and the sealing portion and accommodating a liquid electrolyte, wrinkles formed in the current collectors are reduced.

### BRIEF DESCRIPTION OF DRAWINGS

FIG. 1 is a cross-sectional view of a power storage device.

### DESCRIPTION OF EMBODIMENTS

The following will describe an embodiment according to the present invention with reference to the drawing.

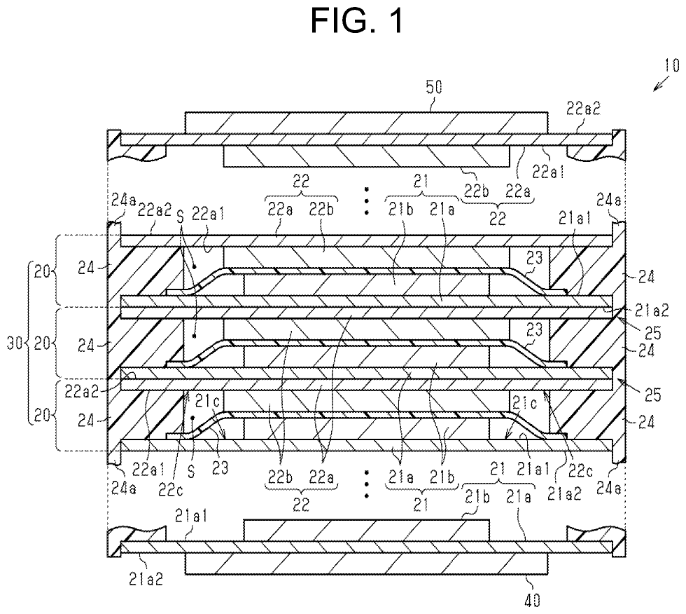

A power storage device 10 as illustrated in FIG. 1 is, for example, a power storage module used for a battery of various vehicles such as a forklift, a hybrid vehicle, and an electric vehicle. Examples of the power storage device 10 include a rechargeable battery such as a nickel-hydrogen secondary battery or a lithium-ion secondary battery. The power storage device 10 may be an electric double-layer capacitor. In the present embodiment, an example in which the power storage device 10 is a lithium-ion battery will be described.

Referring to FIG. 1, the power storage device 10 includes a cell stack 30 (stacked body) formed of a plurality of power storage cells 20 stacked (stacked) in a stacking direction thereof. The stacking direction of the plurality of power storage cells 20 is hereinafter simply called the stacking direction. Each of the power storage cells 20 includes a positive electrode 21, a negative electrode 22, a separator 23, and a sealing portion 24.

The positive electrode 21 includes a positive current collector 21a and a positive electrode active material layer 21b formed on a first surface 21a1 of the positive current collector 21a. In plan view as viewed in the stacking direction (hereinafter, simply called a plan view), the positive electrode active material layer 21b is formed in a middle portion of the first surface 21a1 of the positive current collector 21a. A peripheral edge portion of the first surface 21a1 of the positive current collector 21a in the plan view corresponds to a positive electrode uncoated portion 21c on which the positive electrode active material layer 21b is not formed. The positive electrode uncoated portion 21c is disposed so as to enclose the positive electrode active material layer 21b in the plan view.

The negative electrode 22 includes a negative current collector 22a and a negative electrode active material layer 22b formed on a first surface 22a1 of the negative current collector 22a. In the plan view, the negative electrode active material layer 22b is formed in a middle portion of the first surface 22a1 of the negative current collector 22a. A peripheral edge portion of the first surface 22a1 of the negative current collector 22a in the plan view corresponds to a negative electrode uncoated portion 22c on which the negative electrode active material layer 22b is not formed. The negative electrode uncoated portion 22c is disposed so as to enclose the negative electrode active material layer 22b in the plan view.

The positive electrode 21 and the negative electrode 22 are disposed in such a manner that the positive electrode active material layer 21b and the negative electrode active material layer 22b face each other in the stacking direction. That is, a direction in which the positive electrode 21 and the negative electrode 22 face each other coincides with the stacking direction. The negative electrode active material layer 22b is formed slightly larger than the positive electrode active material layer 21b, and an entire area in which the positive electrode active material layer 21b is formed is located inside an area in which the negative electrode active material layer 22b is formed.

The positive current collector 21a has a second surface 21a2 opposite to the first surface 21a1. The positive electrode 21 is an electrode having a monopolar structure where neither the positive electrode active material layer 21b nor the negative electrode active material layer 22b is formed on the second surface 21a2 of the positive current collector 21a. The negative current collector 22a has a second surface 22a2 opposite to the first surface 22a1. The negative electrode 22 is an electrode having a monopolar structure where neither the positive electrode active material layer 21b nor the negative electrode active material layer 22b is formed on the second surface 22a2 of the negative current collector 22a.

The separator 23 is disposed between the positive electrode 21 and the negative electrode 22 and prevents short circuit between the positive electrode 21 and the negative electrode 22 by keeping a distance therebetween while allowing charge carriers such as lithium ions to pass through the separator 23.

The separator 23 is, for example, a porous sheet or a nonwoven fabric containing a polymer absorbing and keeping the liquid electrolyte inside. As materials for the separator 23, for example, polypropylene, polyethylene, polyolefin, and polyester may be used. The separator 23 may have a monolayer structure or a multilayer structure. The multilayer structure may have, for example, an adhesive layer and a ceramic layer as a heat-resistant layer.

The sealing portion 24 is disposed on outer peripheries of the positive current collector 21a and the negative current collector 22a between the first surface 22a1 of the positive current collector 21a of the positive electrode 21 and the first surface 22a1 of the negative current collector 22a of the negative electrode 22. The sealing portion 24 adheres to both of the positive current collector 21a and the negative current collector 22a. The sealing portion 24 electrically insulates the positive current collector 21a and the negative current collector 22a from each other to prevent short circuit between the current collectors.

The sealing portion 24 is formed in a frame shape extending along the peripheral edge portions of the positive current collector 21a and the negative current collector 22a and enclosing the positive current collector 21a and the negative current collector 22a in the plan view. The sealing portion 24 is disposed between the positive electrode uncoated portion 21c of the first surface 21a1 of the positive current collector 21a and the negative electrode uncoated portion 22c of the first surface 22a1 of the negative current collector 22a.

The power storage cell 20 has therein a sealed space S surrounded by the sealing portion 24 having a frame shape, the positive electrode 21, and the negative electrode 22. The separator 23 and the liquid electrolyte are accommodated in the sealed space S. It is noted that a peripheral edge portion of the separator 23 is embedded in the sealing portion 24. Thus, the sealing portion 24 is disposed between the positive electrode 21 and the negative electrode 22 in such a manner that the sealing portion 24 encloses the positive electrode active material layer 21b and the negative electrode active material layer 22b and adheres to the first surface 21a1 of the positive current collector 21a and the first surface 22a1 of the negative current collector 22a to form the sealed space S between the positive electrode 21 and the negative electrode 22, the sealed space accommodating the liquid electrolyte.

The sealing portion 24 cooperates with the positive electrode 21 and the negative electrode 22 to form the sealed space S to prevent the liquid electrolyte accommodated in the sealed space S from flowing outside the power storage cell 20. In addition, the sealing portion 24 prevents moisture from entering into the sealed space S from the outside of the power storage device 10. Furthermore, the sealing portion 24 prevents, for example, gas generated from the positive electrode 21 or the negative electrode 22 due to a charging or discharging reaction, or the like from leaking outside the power storage device 10.

The cell stack 30 has a structure in which the plurality of power storage cells 20 are stacked in such a manner that the second surface 21a2 of each of the positive current collectors 21a and the second surface 22a2 of each of the negative current collectors 22a are in contact with each other. In this structure, the plurality of power storage cells 20 constituting the cell stack 30 are connected in series.

Here, in the cell stack 30, a simulated bipolar electrode 25, in which the positive current collector 21a and the negative current collector 22a that are in contact with each other are regarded as one current collector, is formed of any two of the power storage cells 20 adjacent in the stacking direction. The simulated bipolar electrode 25 includes a current collector having a structure in which the positive current collector 21a is stacked on the negative current collector 22a, the positive electrode active material layer 21b formed on one surface of the current collector, and the negative electrode active material layer 22b formed on the other surface of the current collector.

The sealing portion 24 of each of the power storage cells 20 has an outer peripheral portion 24a extending outward beyond each edge portion of the positive current collector 21a and the negative current collector 22a. As viewed in the stacking direction, the outer peripheral portion 24a protrudes in a direction orthogonal to the stacking direction beyond each edge portion of the positive current collector 21a and the negative current collector 22a. Any two of the power storage cells 20 adjacent in the stacking direction are integrated by causing the outer peripheral portion 24a of the sealing portion 24 of one of the power storage cells 20 and the outer peripheral portion 24a of the sealing portion 24 of the other of the power storage cell 20 to adhere to each other. Examples of a method of causing the adjacent sealing portions 24 to adhere to each other include a known welding method such as heat welding, ultrasonic welding, or infrared welding.

The power storage device 10 includes a pair of current conductors, that is, a positive electrode conductive plate 40 and a negative electrode conductive plate 50 that are disposed so as to hold the cell stack 30 therebetween in the stacking direction of the cell stack 30. The positive electrode conductive plate 40 and the negative electrode conductive plate 50 are each made of a material superior in conductivity.

The positive electrode conductive plate 40 is electrically connected to the second surface 21a2 of the positive current collector 21a of the positive electrode 21 that is disposed on one end of the cell stack 30 in the stacking direction. The negative electrode conductive plate 50 is electrically connected to the second surface 22a2 of the negative current collector 22a of the negative electrode 22 that is disposed on the other end of the cell stack 30 in the stacking direction.

The power storage device 10 is charged or discharged through terminals provided in the positive electrode conductive plate 40 and the negative electrode conductive plate 50. The same material as that used for the positive current collector 21a may be used for the positive electrode conductive plate 40. The positive electrode conductive plate 40 may be made of a metal plate thicker than that of the positive current collector 21a used for the cell stack 30. The same material as that used for the negative current collector 22a may be used for the negative electrode conductive plate 50. The negative electrode conductive plate 50 may be made of a metal plate thicker than that of the negative current collector 22a used for the cell stack 30.

The following will describe details of the positive current collector 21a, the negative current collector 22a, the positive electrode active material layer 21b, the negative electrode active material layer 22b, the liquid electrolyte, and the sealing portion 24.

<Positive Current Collector and Negative Current Collector>

The positive current collector 21a and the negative current collector 22a are a chemically inactive electric conductor through which a current flows continuously into the positive electrode active material layer 21b and the negative electrode active material layer 22b during the charging or discharging of the lithium-ion secondary battery.

One of the positive current collector 21a and the negative current collector 22a is made of aluminum foil, and the other of the positive current collector 21a and the negative current collector 22a is made of aluminum foil or copper foil. In one preferable example of the positive current collector 21a and the negative current collector 22a, the positive current collector 21a is made of aluminum foil and the negative current collector 22a is made of copper foil.

A thickness of the above-describe aluminum foil is from 1 to 50 μm, or preferably from 1 to 20 μm. Energy density of the power storage cell 20 is increased by using thin aluminum foil. In addition, a height of the power storage device 10 in the stacking direction is lowered by using the thin aluminum foil.

The above-described aluminum foil has a proof stress, which is calculated as a product of Young's modulus and thickness. The proof stress is preferably 70 MPa·mm or more and preferably 1050 MPa·mm or less, for example.

A thickness of the above-describe copper foil is from 1 to 25 μm, or preferably from 1 to 15 μm. The energy density of the power storage cell 20 is increased by using thin copper film. In addition, a height of the power storage device 10 in the stacking direction is lowered by using the thin copper foil.

The above-described copper foil has a proof stress, which is calculated as the product of the Young's modulus and the thickness. The proof stress is preferably 120 MPa·mm or more and preferably 1800 MPa·mm or less, for example.

Surfaces of the above-described aluminum foil and copper foil may be covered with a known protective layer or treated using a known method such as plating.

It is noted that in the following description, the positive current collector 21a and the negative current collector 22a are simply called the current collector when not being identified.

<Positive Electrode Active Material Layer and Negative Electrode Active Material Layer>

The positive electrode active material layer 21b contains a positive electrode active material that absorbs and desorbs charge carriers such as lithium-ions. In one example, a lithium composite metal oxide having a layered rock salt structure, a metal oxide having a spinel structure, and a polyanionic compound are usable as the positive electrode active material of the lithium-ion secondary battery. Two or more kinds of positive electrode active materials may be used in combination. In the present embodiment, the positive electrode active material layer 21b contains olivine-type lithium iron phosphate (LiFePO₄) as the polyanionic compound.

The negative electrode active material layer 22b is not limited to any particular material and any material is usable for the negative electrode active material layer 22b as long as the negative electrode active material layer 22b is made of a single substance, an alloy, or a compound that absorbs and desorbs charge carriers such as lithium-ions. Examples of the negative electrode active material includes Li, carbon, a metal compound, an element alloyed with lithium, a compound thereof, and the like. Examples of the carbon include natural graphite, artificial graphite, hard carbon (non-graphitizing carbon), and soft carbon (graphitizing carbon). Examples of the artificial carbon include highly oriented graphite, mesocarbon microbeads, and the like. Examples of the element alloyed with lithium include silicon (silicon) and tin. In the present embodiment, the negative electrode active material layer 22b contains graphite as carbon-based materials.

The positive electrode active material layer 21b and the negative electrode active material layer 22b (hereinafter, also simply called active material layer) may further contain a conductive assistant, a binder, an electrolyte (polymer matrix, ion-conducting polymer, liquid electrolyte, and the like), and an electrolyte supporting salt (lithium salt) that increases ionic conductivity, and the like. Components contained in the active material layer or a compounding ratio of the components, and a thickness of the active material layer are not limited to any particular components, any particular compounding ratio, and any particular thickness and may be determined with reference to public knowledge for the lithium-ion secondary battery as appropriate. The thickness of the active material layer is, for example, 2 to 150 μm.

The conductive assistant is added in order to increase conductivity of the positive electrode 21 or the negative electrode 22. The conductive assistant is, for example, acetylene black, carbon black, or graphite.

Examples of the binder include: fluorine-containing resins such as polyvinylidene fluoride, polytetrafluoroethylene, and fluorine rubber; thermoplastic resins such as polypropylene and polyethylene; imide-based resins such as polyimide and polyamide-imide; alkoxysilyl group-containing resins; acrylic resins such as poly(meth)acrylic acid; styrene-butadiene rubber; carboxymethyl cellulose; alginates such as sodium alginate and ammonium alginate; water-soluble cross-linked cellulose ester; and starch-acrylic acid graft polymers. These binders may be used alone or in any combination of two or more. Water, N-methyl-2-pyrrolidone, or the like is used as a solvent or a dispersion medium.

A known method such as a roll coating method may be used to form the active material layer on the surfaces of the positive current collector 21a and the negative current collector 22a.

In order to enhance thermal stability of the positive electrode 21 or the negative electrode 22, the above-described heat-resistant layer may be formed on the surface of the active material layer.

<Sealing Portion>

A thickness of the sealing portion 24 is, for example, preferably from 50 to 1000 μm, more preferably from 100 to 800 μm.

The sealing portion 24 is made of thermoplastic polyolefin-based resin. Examples of the thermoplastic polyolefin-based resin include polyethylene (PE), polypropylene (PP), modified polyethylene (modified PE), modified polypropylene (modified PP), isoprene, modified isoprene, polybutene, modified polybutene, and polybutadiene. Examples of the modified polyethylene include acid modified polyethylene and epoxy modified polyethylene. Examples of the modified polypropylene include acid modified polypropylene and epoxy modified polypropylene. It is noted that two or more of the polyolefin-based resins as described above may be used in combination.

The above-described thermoplastic polyolefin-based resin has a peak top temperature of 135° C. or less. The peak top temperature of thermoplastic polyolefin-based resin corresponds to a welding temperature at which an adhesive strength of a stacked body that is formed by causing aluminum foils or aluminum foil and copper foil to adhere to each other with thermoplastic polyolefin-based resin interposed therebetween by heat welding becomes maximum relative to a temperature during the heat welding. The adhesive strength is a value calculated by dividing a peel strength obtained by a 1800 peeling test by an adhesion width.

It is noted that the adhesive strength between the positive current collector 21a and the negative current collector 22a that are caused to adhere to each other with the sealing portion 24 is preferably 0.8 N/mm or more, or more preferably 1.0 N/mm or more.

A melting point of the above-described thermoplastic polyolefin-based resin is, for example, preferably 70° C. or more, or more preferably 90° C. or more.

A coefficient of linear expansion of the thermoplastic polyolefin-based resin is, for example, preferably 25×10⁻⁵/° C. or less, or more preferably 15×10⁻⁵/° C. or less. When the coefficient of linear expansion of the above-described thermoplastic polyolefin-based resin is 15×10⁻⁵/° C. or less, an effect of reducing wrinkles formed in the current collector is enhanced.

<Liquid Electrolyte>

Examples of the liquid electrolyte include a liquid electrolyte containing a non-aqueous solvent and an electrolyte salt dissolved in the non-aqueous solvent. A known lithium salt such as LiClO₄, LiAsF₆, LiPF₆, LiBF₄, LiCF₃SO₃, LiN(FSO₂)₂, or LiN(CF₃SO₂)₂ may be used as the electrolyte salt. A known solvent such as cyclic carbonates, cyclic esters, chain carbonates, chain esters, or ethers may be used as the non-aqueous solvent. It is noted that two or more of these known solvents may be used in combination.

The following will describe a method of manufacturing the power storage device 10 according to the present embodiment.

The power storage device 10 is manufactured through an electrode forming process, a power storage cell forming process, and a cell stack forming process performed in this order.

<Electrode Forming Process>

The electrode forming process includes a positive electrode forming process of forming the positive electrode 21 and a negative electrode forming process of forming the negative electrode 22.

The positive electrode forming process is not limited to any particular method, and a known method may be applied to form the positive electrode 21 including the positive current collector 21a and the positive electrode active material layer 21b. For example, a positive electrode mixture to be the positive electrode active material layer 21b by solidifying is applied on the first surface 21a1 of the aluminum foil as the positive current collector 21a in such a manner that the applied positive electrode mixture has a specified thickness, and then, a solidifying process suitable for the positive electrode mixture is performed to form the positive electrode 21.

The negative electrode forming process is not limited to any particular method, and a known method may be applied to form the negative electrode 22 including the negative current collector 22a and the negative electrode active material layer 22b. For example, a negative electrode mixture to be the negative electrode active material layer 22b by solidifying is applied on the first surface 22a1 of the copper foil as the negative current collector 22a in such a manner that the applied negative electrode material has a specified thickness, and then, a solidifying process suitable for the negative electrode mixture is performed to form the negative electrode 22.

<Power Storage Cell Forming Process>

In the power storage cell forming process, firstly, the positive electrode 21 and the negative electrode 22 are arranged in such a manner that the positive electrode active material layer 21b and the negative electrode active material layer 22b face each other in the stacking direction with the separator 23 interposed therebetween, and a sealing material to be the sealing portion 24 is disposed on the outer peripheries of the positive electrode active material layer 21b and the negative electrode active material layer 22b between the positive electrode 21 and the negative electrode 22. In one example, a resin sheet made of the above-described thermoplastic polyolefin-based resin and having a thickness of 50 to 100 μm is cut in the same shape as the shape of the sealing portion 24 in plan view as the sealing material.

Then, the sealing material is heated at a temperature of 135° C. or less, or preferably at the peak top temperature of the above-described thermoplastic polyolefin-based resin constituting the sealing material to cause the sealing material to adhere to the positive electrode 21, the negative electrode 22, and the separator 23 by heat welding. The heat-welded sealing material forms the sealing portion 24. Thus, the positive electrode 21, the negative electrode 22, the separator 23, and the sealing portion 24 are integrated to form an assembly body.

Next, a liquid electrolyte is poured into the sealed space S inside the assembly body through an inlet that is disposed in a part of the sealing portion 24, and then, the inlet is sealed. Thus, the power storage cell 20 is formed.

<Cell Stack Forming Process>

In the cell stack forming process, firstly, the plurality of power storage cells 20 are stacked in such a manner that the second surface 21a2 of each of the positive current collectors 21a and the second surface 22a2 of each of the negative current collector 22a face each other. Then, the outer peripheral portions 24a of the sealing portions 24 in any two of the power storage cells 20 adjacent in the stacking direction are caused to adhere to each other to integrate the plurality of power storage cells 20.

Next, the positive electrode conductive plate 40 is stacked on and fixed to the second surface 21a2 of the positive current collector 21a of the positive electrode 21 disposed on the one end of the cell stack 30 in the stacking direction in an electrically connected state. Similarly, the negative electrode conductive plate 50 is stacked on and fixed to the second surface 22a2 of the negative current collector 22a of the negative electrode 22 disposed on the other end of the cell stack 30 in the stacking direction in an electrically connected state.

The present embodiment provides the following advantages.
(1) The power storage device 10 includes the positive electrodes 21 each having the positive current collector 21a and the positive electrode active material layer 21b, the negative electrodes 22 each having the negative current collector 22a and the negative electrode active material layer 22b, the separator 23 interposed between the positive electrode active material layer 21b and the negative electrode active material layer 22b, and the sealing portion 24 cooperating with the positive electrode 21 and the negative electrode 22 to form the sealed space S accommodating the liquid electrolyte.

One of the positive current collector 21a and the negative current collector 22a is made of aluminum foil having a thickness of 1 to 50 μm. The other of the positive current collector 21a and the negative current collector 22a is made of aluminum foil having a thickness of 1 to 50 μm or copper foil having a thickness of 1 to 25 μm. The sealing portion 24 is made of thermoplastic polyolefin-based resin. The thermoplastic polyolefin-based resin has the peak top temperature of 135° C. or less, which corresponds to the welding temperature at which the adhesive strength becomes maximum.

In the above-described configuration, aluminum foil and thermoplastic polyolefin-based resin having the peak top temperature of 135° C. or less are used as a combination of a material constituting the current collector and a material constituting the sealing portion 24. When employing current collectors having a small proof stress, this configuration reduces wrinkles formed in the current collectors due to a change in volume of the sealing portion 24. Reducing the wrinkles formed in the current collectors prevents short circuit between the current collectors and leakage of the liquid electrolyte from the sealed space S sealed with the sealing portion 24.
(2) The thermoplastic polyolefin-based resin constituting the sealing portion 24 has a coefficient of linear expansion of 25×10⁻⁵/° C. or less.

This configuration enhances the effect of reducing the wrinkles formed in the positive current collectors 21a and the negative current collectors 22a.
(3) The power storage device 10 has a structure in which the positive electrode 21, the negative electrode 22, and the separator 23 are stacked one another, and the second surface 21a2 opposite to the first surface 21a1 in the positive current collector 21a and the second surface 22a2 opposite to the first surface 22a1 in the negative current collector 22a are in contact with each other.

In the power storage device 10 having the above-described configuration, the wrinkles formed in the positive current collectors 21a and the negative current collectors 22a cause a reduction of adhesion between the second surface 21a2 of the positive current collector 21a and the second surface 22a2 of the negative current collector 22a at a contact portion therebetween and an increase of a contact resistance associated with the reduction of adhesion. Accordingly, reducing the wrinkles formed in the positive current collectors 21a and the negative current collectors 22a not only prevents the short circuit of the current collectors and the leakage of the liquid electrolyte but also suppresses a reduction of a battery performance.

The present embodiment will be modified as described below. The present embodiment and the modifications below may be combined as long as there is no technical contradiction.

Shapes of the positive current collector 21a and the positive electrode active material layer 21b in the plan view are not particularly limited. The shapes in the plan view may be a polygonal shape such as a rectangular, a circle, or an ellipse. The same goes for the negative current collector 22a and the negative electrode active material layer 22b.

The shape of the sealing portion 24 in plan view is not particularly limited, and may be a polygonal shape such as a rectangular, a circle, or an ellipse.

A conductive layer adhering to the positive current collector 21a may be formed between the positive electrode conductive plate 40 and the positive current collector 21a in order to obtain a good electrical contact therebetween. Examples of the conductive layer include a layer having a hardness lower than that of the positive current collector 21a made of a plating layer containing Au or a layer containing carbon such as acetylene black or graphite. The same conductive layer as that as described above may be formed between the negative electrode conductive plate 50 and the negative current collector 22a.

The number of the power storage cells 20 constituting the power storage device 10 is not particularly limited. The number of the power storage cells 20 constituting the power storage device 10 may be one.

The positive electrode active material layer 21b or the negative electrode active material layer 22b may be formed on the second surface 21a2 of each of the positive current collectors 21a. In addition, the positive electrode active material layer 21b and the negative electrode active material layer 22b may be formed on the second surface 22a2 of each of the negative current collectors 22a.

The following will describe a technical idea that can been seen from the above-described embodiment and the modifications.
(I) A method of manufacturing the power storage device, the method comprising: disposing the positive electrode and the negative electrode in such a manner that the positive electrode active material layer and the negative electrode active material layer face each other in a stacking direction thereof with the separator interposed therebetween, and disposing a sealing material on outer peripheries of the positive electrode active material layer and the negative electrode active material layer between the positive electrode and the negative electrode; and forming the sealing portion by heat welding in which the sealing material is heated at a temperature of 135° C. or less to cause the sealing material to adhere to the positive electrode, the negative electrode, and the separator.

### EXAMPLE

The following will describe an example further embodying the above-described embodiment.

(Measurement of a Peak Top Temperature of Thermoplastic Polyolefin-Based Resin)

Aluminum foil having a rectangular shape of 90 mm wide by 150 mm deep and a thickness of 15 μm, and copper foil having the same shape as that of the aluminum foil and a thickness of 10 μm were prepared. After a sealing material having a rectangular shape of 15 mm wide by 150 mm deep by 100 μm thick was disposed on the aluminum foil in such a manner that an edge of the sealing material was aligned with an edge of the aluminum foil, the copper foil was disposed on top of such sealing material in such a manner that an edge of the copper foil was aligned with the edge of the aluminum foil to form a stacked body. A resin sheet made of one of acid modified polyethylene resins (PE-A, PE-B) and acid modified polypropylene resins (PP-A, PP-B) as described below was used as the sealing material.
PE-A: an acid modified polyethylene resin of a melting point 95° C. and a coefficient of linear expansion 22×10⁻⁵/° C.
PE-B: an acid modified polyethylene resin of a melting point 85° C. and a coefficient of linear expansion 13×10⁻⁵/° C.
PP-A: an acid modified polypropylene resin of a melting point 160° C. and a coefficient of linear expansion 10×10⁻⁵/° C. PP-B: an acid modified polypropylene resin of a melting point 120° C. and
a coefficient of linear expansion 12×10⁻⁵/° C.

Next, the sealing material was heated using an impulse sealer to cause the aluminum foil and the copper foil to adhere to each other with the sealing material interposed therebetween. The sealing material was heated for 9.9 seconds under a pressure of 0.5 Mpa using the impulse sealer in which a current is set so as to heat the sealing material to a welding temperature shown in Tables. 1 and 2.

A strip obtained by cutting the stacked body that was obtained by the adhesion in a width of 15 mm orthogonally to an adhering edge of the stacked body was used as the measurement samples. A peel strength of each of the measurement samples was measured by a 180° peeling test in which the aluminum foil and the copper foil of the measurement sample are peeled from each other at room temperature. Then, an adhesive strength of each of the measurement samples was calculated based on the following Equation (1). The calculated results are shown in Tables 1 and 2.

Adhesive strength(N/mm)=peel strength(N)+15 mm (1)

Next, a peak top temperature Tp of each of the thermoplastic polyolefin-based resins was calculated from a graph (not shown) on which a relationship between the calculated adhesive strength and the welding temperature was plotted. The calculated results are shown in Tables 1 and 2.

TABLE 1

| | PE-A | | | | | PE-B | | | | |
|---|---|---|---|---|---|---|---|---|---|---|
| Welding temperature (° C.) | 105 | 120 | 130 | 140 | 165 | 105 | 120 | 130 | 140 | 165 |
| Adhesive strength(N/mm) | 1.25 | 1.98 | 1.96 | 1.83 | 0.95 | 0.92 | 1.42 | 1.41 | 1.25 | 0.99 |

| | | |
|---|---|---|
| Tp(° C.) | 120 | 120 |

TABLE 2

| | PP-A | | | PP-B | | | |
|---|---|---|---|---|---|---|---|
| Welding temperature (° C.) | 120 | 140 | 165 | 120 | 130 | 140 | 165 |
| Adhesive strength(N/mm) | <0.01 | <0.01 | 1.29 | 1.44 | 1.46 | 1.23 | 1.03 |

| | | |
|---|---|---|
| Tp(° C.) | 165 | 130 |

(Evaluation of Wrinkles and Short-Circuit)

Aluminum foil having a rectangular shape of 60 mm wide by 600 mm deep and a thickness of 15 μm, and copper foil having the same shape as that of the aluminum foil and a thickness of 10 μm were prepared. After a sealing material having a rectangular shape of 18 mm wide by 600 mm deep by 100 μm thick was disposed on the aluminum foil in such a manner that an edge of the sealing material was aligned with an edge of the aluminum foil, the copper foil was disposed on top of such sealing material in such a manner that an edge of the copper foil was aligned with the edge of the aluminum foil to form a stacked body. A kind of the sealing materials is shown in Table 3.

Next, the sealing material was heated to the peak top temperature of each of the thermoplastic polyolefin-based resins constituting the sealing material using the impulse sealer to cause the aluminum foil and the copper foil to adhere to each other with the sealing material interposed therebetween. A strip obtained by cutting the stacked body obtained by the adhesion in an area of 60 mm wide by 100 mm deep was used as the measurement sample.

Surfaces of the aluminum foil and the copper foil of the measurement sample were visually observed, and the number of wrinkles formed on each surface was counted. In addition, terminals are connected to the aluminum foil and the copper foil of the measurement sample, and an electrode resistance is determined by measuring a voltage between the terminals. These results are shown in Table 3. It is noted that “R.O.” shown in a column of an electric resistance in Table 3 represents a rated output.

(Liquid Leakage Test)

Aluminum foil (Al foil) having a square shape of 150 mm wide by 150 mm deep and a thickness of 10 μm or 15 μm, and copper foil having the same shape as that of the aluminum foil and a thickness of 10 μm or 30 μm were prepared. A sealing material having a square flame shape of 150 mm wide by 150 mm deep by 10 mm flame wide and the copper foil were stacked on the aluminum foil in such a manner that the aluminum foil, the sealing material, and the copper foil were arranged in this order in the stacking direction to form a stacked body. Kinds of the sealing material are shown in Table 3.

Next, areas of 10 mm width in three sides of the stacked body were heated to the peak top temperature of the thermoplastic polyolefin-based resin constituting the sealing material using the impulse sealer to cause the aluminum foil and the copper foil to adhere to each other with the sealing material interposed therebetween. A liquid electrolyte of 3 ml was poured into the stacked body from a non-adhering side of the stacked body, and then, the stacked body was sealed at the non-adhering side by vacuum sealing to form each of measurement samples. The liquid electrolyte was made by dissolving LiPF₆ in a mixed solvent of ethylene carbonate, ethyl methyl carbonate, and dimethyl carbonate with a volume ratio of 30:30:40 in such a way that a concentration of the LiPF₆ reaches 1 M.

The measurement samples were left for seven days at a temperature of 60° C. A mass of each of the measurement samples was measured before and after the leaving, and a difference in mass between the measurement sample before the leaving and the measurement sample after the leaving was calculated. The calculated value was defined as an amount of leakage of the liquid electrolyte. The results are shown in Table 3.

TABLE 3

| | Sealing portion | | | Current collector | | | | | |
|---|---|---|---|---|---|---|---|---|---|
| | | | Coefficient of linear | Thickness of | Thickness of | The number of wrinkles | | Electric | Amount of |
| | | Tp | expansion | Aluminum film | Copper film | Aluminum | Copper | resistance | leakage |
| | Kind of resin | (° C.) | (×10⁻⁵/° C.) | (μm) | (μm) | film | film | (Ω) | (g) |
| Test example 1 | PE-A | ≤135 | 22 | 15 | 10 | 1 | 0 | R.O. | 0 |
| Test example 2 | PE-B | ≤135 | 13 | 15 | 10 | 0 | 0 | R.O. | 0 |
| Test example 3 | PP-A | 135< | 10 | 15 | 10 | 20 | 18 | 103 | 1.4 |
| Test example 4 | PP-A | 135< | 10 | 10 | 30 | 17 | 1 | R.O. | 0.5 |

As shown in Table 3, in test examples 3 and 4 in which each resin having the peak top temperature Tp greater than 135° C. as the resin constituting the sealing portion was used, many wrinkles were seen in the aluminum foil and the copper foil, and the leakage of the liquid electrolyte was also seen. In addition, in the test example 3, short circuit between the aluminum foil and the copper foil occurred.

Meanwhile, in test examples 1 and 2 in which each resin having the peak top temperature Tp of 135° C. or less was used, wrinkles formed in the aluminum foil and the copper foil were remarkably reduced as compared to the test examples 3 and 4. In particular, in the test example 2 in which the resin having the coefficient of linear expansion of 15×10⁻⁵/° C. or less was used, no wrinkle was formed. Short circuit and leakage of the liquid electrolyte were not seen in the test examples 1 and 2. Although a detail description is omitted, also in the same test performed by using PP-B having the peak top temperature Tp of 130° C., short circuit and leakage of the liquid electrolyte were not seen as well as wrinkles formed in the aluminum foil and the copper foil were remarkably reduced.

### REFERENCE SIGNS LIST

S sealed space
10 power storage device
20 power storage cell
21 positive electrode
21a positive current collector
21b positive electrode active material layer
22 negative electrode
22a negative current collector
22b negative electrode active material layer
23 separator
24 sealing portion
30 cell stack
40 positive electrode conductive plate
50 negative electrode conductive plate

1. A power storage device comprising:
a positive electrode including a positive electrode active material layer formed on a first surface of a positive current collector;
a negative electrode including a negative electrode active material layer formed on a first surface of a negative current collector, the negative electrode active material layer being disposed so as to face the positive electrode active material layer of the positive electrode;
a separator interposed between the positive electrode active material layer and the negative electrode active material layer; and
a sealing portion disposed between the positive electrode and the negative electrode in such a manner that the sealing portion encloses the positive electrode active material layer and the negative electrode active material layer, the sealing portion adhering to the first surface of the positive current collector and the first surface of the negative current collector to form a sealed space between the positive electrode and the negative electrode, the sealed space accommodating a liquid electrolyte, wherein
one of the positive current collector and the negative current collector is made of aluminum foil having a thickness of 1 to 50 μm,
the other of the positive current collector and the negative current collector is made of aluminum foil having a thickness of 1 to 50 μm, or copper foil having a thickness of 1 to 25 μm,
the sealing portion is made of thermoplastic polyolefin-based resin, and
the thermoplastic polyolefin-based resin has a peak top temperature of 135° C. or less, which corresponds to a welding temperature at which an adhesive strength becomes maximum.

2. The power storage device according to claim 1, wherein
the other of the positive current collector and the negative current collector is made of copper foil having a thickness of 1 to 25 μm.

3. The power storage device according to claim 1, wherein
the thermoplastic polyolefin-based resin has a coefficient of linear expansion of 25×10⁻⁵/° C. or less.

4. The power storage device according to claim 1, wherein
the power storage device has a structure in which the positive electrode, the negative electrode, and the separator are stacked one another, and a second surface opposite to the first surface in the positive current collector and a second surface opposite to the first surface in the negative current collector are in contact with each other.

5. (canceled)
